(19) United States
(12) Patent Application Publication
(10) Pub. No.: US 2022/0253844 A1
(43) Pub. Date: Aug. 11, 2022

(54) BLOCKCHAIN-BASED TRANSACTIONS OF DIGITAL CONTENT

(71) Applicants: AT&T Intellectual Property I, L.P., Atlanta, GA (US); AT&T Mobility II LLC, Atlanta, GA (US)

(72) Inventors: Bhumit Patel, Smyrna, GA (US); Jonathan Chang, Atlanta, GA (US); Wasib Khallil, Lilburn, GA (US); Iftekhar Alam, Roswell, GA (US)

(73) Assignees: AT&T Intellectual Property I, L.P., Atlanta, GA (US); AT&T Mobility II LLC, Atlanta, GA (US)

(21) Appl. No.: 17/172,350

(22) Filed: Feb. 10, 2021

(51) Int. Cl. G06Q 20/40; G06F 21/10; G06Q 20/38; G06Q 30/06

(52) U.S. Cl. CPC G06Q 20/401; G06F 21/10; G06Q 2220/10; G06Q 30/0601; G06F 2221/0713; G06Q 20/3829

(57) ABSTRACT

Aspects of the subject disclosure may include, for example, obtaining, from a content system, transaction information associated with a first digital content item, where the transaction information relates to a purchase of the first digital content item by a first user, processing, using a blockchain network, the transaction information to validate the purchase, based on validating the purchase, generating, using the blockchain network, a first block of data, adding, using the blockchain network, the first block of data to a blockchain, deriving, a first unique identifier for the first digital content item, and providing the first unique identifier to the content system, where the providing the first unique identifier causes the content system to associate the first unique identifier with a first user account associated with the first user, such that the first user is permitted to access the first digital content item. Other embodiments are disclosed.

### FIELD OF THE DISCLOSURE

The subject disclosure relates to blockchain-based transactions of digital content.

### BACKGROUND

With continued popularization of the Internet and advancements in web-based technology, it has become increasingly popular to publish and consume content in digital form—i.e., digital media or content that is transmitted and/or used over the web, such as video games, movies, music, books, etc. Unlike traditional forms of media (e.g., video game disks, hard- or soft-cover books, etc.), digital content can be accessed by a user almost anywhere with an electronic device, without the user having to carry or handle any additional physical objects, such as disks or the like.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communications network of FIG. 1 in accordance with various aspects described herein.

FIG. 2B is a block diagram illustrating an example, non-limiting embodiment of a system functioning within the communications network of FIG. 1 and/or the system of FIG. 2A in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

In stark contrast to traditional physical media or objects, such as a video game disk or the like, which a consumer is generally able to sell or resell to a store or other buyer for a full or partial credit, there is no outlet for a consumer to sell or resell their digital media products, for any amount of credit. Lack of a means to conduct post-purchase sales of digital content items can deter one from purchasing such products in the first place, especially if their initial costs are high.

The subject disclosure describes, among other things, illustrative embodiments of a transaction management platform that is capable of facilitating transactions (e.g., resale transactions) associated with digital content items (e.g., video games, applications, books, movies, music, and/or the like), and managing user access to the digital content items based on the transactions. In exemplary embodiments, the transaction management platform may be implemented as a Software-as-a-Service (SaaS) system, and may have access to (e.g., may include or leverage) a blockchain network to verify or validate transactions.

In various embodiments, the transaction management platform may, based on a user request to make an original purchase (e.g., the initial or first purchase) of a digital content item from a content system (e.g., a virtual (e.g., online) store server and/or a content server capable of providing the user with access to the digital content item), validate the transaction (e.g., using the blockchain network), generate a block of data regarding the transaction, add the block of data to a blockchain, generate a unique identifier (e.g., a hash key and/or the like) for the digital content item, and provide the unique identifier to the content system. The content system can associate the unique identifier with the user's account to enable the user to access and/or consume the digital content item. In some embodiments, the transaction management platform may perform the foregoing actions if (e.g., only if) the original purchase is made along with an option (e.g., a resale option) for the ability or right to resell the digital content item. In various embodiments, choosing the resale option, when making an original purchase of a digital content item, may require payment of an additional, upfront fee (e.g., on top of, or in excess of, a base price or cost of the digital content item).

In various embodiments, the transaction management platform may, based on a request from the user to resell the digital content item (e.g., to advertise or list the digital content item for resale), identify, using the unique identifier, the block of data (in the blockchain) corresponding to the unique identifier, deactivate, or otherwise manipulate, the block of data such that a record of the user's association with the digital content item is removed, archived, nullified, and/or the like, and provide an instruction to the content system to remove the user's access to the digital content item (e.g., to delete the unique identifier associated with the user's account on the content system). In certain embodiments, the transaction management platform may suggest a resale price for a digital content item based on a variety of factors, such as user demand, popularity, release date, etc. In various embodiments, the transaction management platform may charge a user a service fee (e.g., based on a percentage of the resale price) for facilitating the resale of a digital content item. In various embodiments, a user may be permitted to resell a digital content item if (e.g., only if) the option for the ability or right to resell the digital content item (e.g., the resale option) was selected during the original purchase of the digital content item (e.g., by the user or a prior user).

In various embodiments, the transaction management platform may, based on a request from a different user to purchase the digital content item that is for resale, facilitate a resale transaction, which may include validating the resale transaction (e.g., using the blockchain network), generating another block of data regarding the resale transaction, adding that block of data to the blockchain, generating another unique identifier (e.g., another hash key and/or the like) for the digital content item, and providing that unique identifier to the content system to enable that user to access and/or consume the digital content item.

Embodiments of the transaction management platform provide a central marketplace for consumers of digital content to purchase and sell “used” digital content items (e.g., at discounted prices). Leveraging a blockchain network, in the transaction management platform, to facilitate transactions relating to digital content items (including, e.g., resale transactions therefor) enables secure recordkeeping of the transactions, and reduces or eliminates a need to rely on third-party verification systems (and their associated application programming interfaces (APIs)). Associating a different unique identifier (e.g., hash key) with a digital content item when the digital content item is resold (e.g., each time the digital content item is resold), and managing user access based on the latest unique identifier, also ensures that only legally acquired digital content items can be resold through the platform. Permitting a content provider (e.g., a virtual store or marketplace provider, a digital content publisher or provider, and/or the like) to charge an upfront fee in exchange for a resale option, as described herein, also incentivizes the content provider to adopt the transaction management platform.

One or more aspects of the subject disclosure include a device, comprising a processing system including a processor, and a memory that stores executable instructions that, when executed by the processing system, facilitate performance of operations. The processing system can have access to a blockchain network. The operations can include obtaining, from a content system, transaction information associated with a first digital content item, where the transaction information relates to a purchase of the first digital content item by a first user. Further, the operations can include processing, using the blockchain network, the transaction information to validate the purchase, and based on validating the purchase, generating, using the blockchain network, a first block of data. Further, the operations can include adding, using the blockchain network, the first block of data to a blockchain, deriving, a first unique identifier for the first digital content item, and providing the first unique identifier to the content system, where the providing the first unique identifier causes the content system to associate the first unique identifier with a first user account associated with the first user, such that the first user is permitted to access the first digital content item.

One or more aspects of the subject disclosure include a non-transitory machine-readable medium, comprising executable instructions that, when executed by a processing system including a processor, facilitate performance of operations. The operations can include providing, to a transaction management platform, transaction information associated with a first digital content item, where the transaction information relates to a purchase of the first digital content item by a first user, and where the providing the transaction information enables the transaction management platform to process, using a blockchain network, the transaction information to validate the purchase, and to generate, based on validating the transaction information, a first unique identifier for the first digital content item. Further, the operations can include receiving, from the transaction management platform, the first unique identifier responsive to the providing the transaction information to the transaction management platform, and based on the receiving the first unique identifier, causing the first unique identifier to become associated with a first user account corresponding to the first user to enable the first user to access and consume the first digital content item.

One or more aspects of the subject disclosure include a method. The method can comprise receiving, by a processing system including a processor, a request to purchase a first digital content item, where the processing system has access to a blockchain network, where the first digital content item is available for resale via the processing system, and where the request originates from a first user device associated with a first user. Further, the method can include determining, by the processing system and based on the request, to facilitate a resale transaction for the first digital content item, based on the determining, generating, by the processing system using the blockchain network, a first block of data, adding, by the processing system using the blockchain network, the first block of data to a blockchain, deriving, by the processing system, a first unique identifier for the first digital content item, and providing, by the processing system, the first unique identifier to a content system, where the providing the first unique identifier causes the content system to associate the first unique identifier with a first user account associated with the first user, such that the first user is permitted to access the first digital content item.

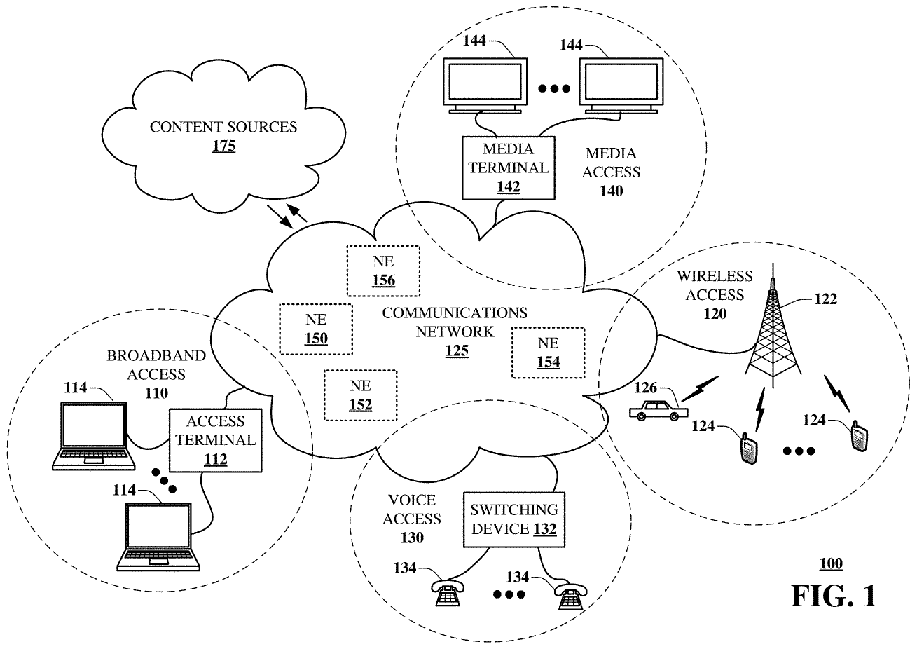

Referring now to FIG. 1, a block diagram is shown illustrating an example, non-limiting embodiment of a system 100 in accordance with various aspects described herein. For example, system 100 can facilitate, in whole or in part, processing of transactions (e.g., resale transactions) associated with digital content items (e.g., video games, applications, books, movies, music, and/or the like), and managing user access to the digital content items based on the transactions. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

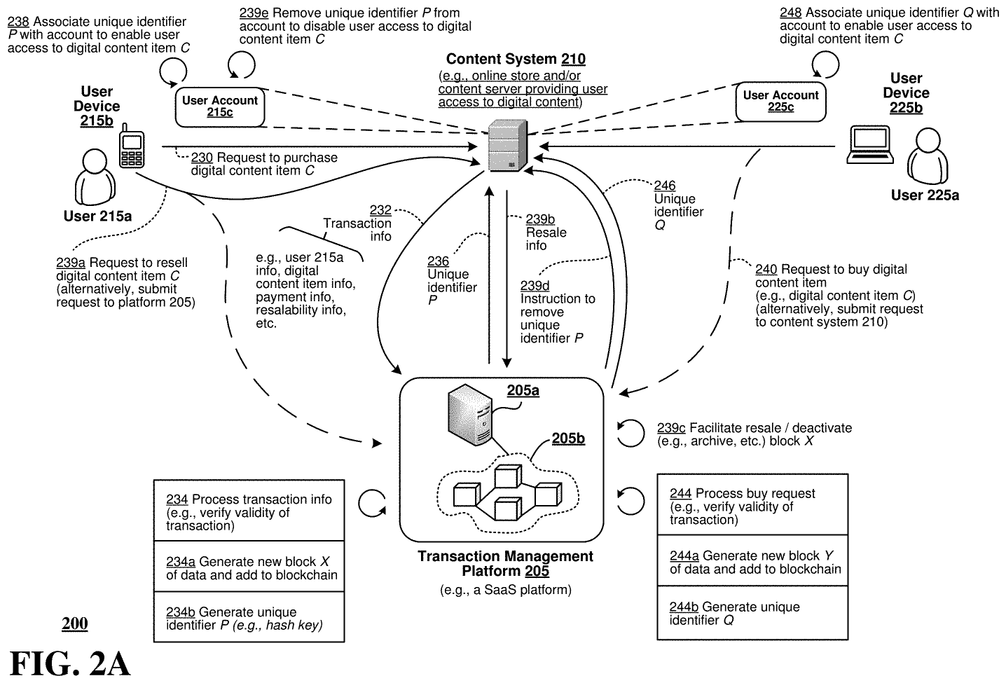

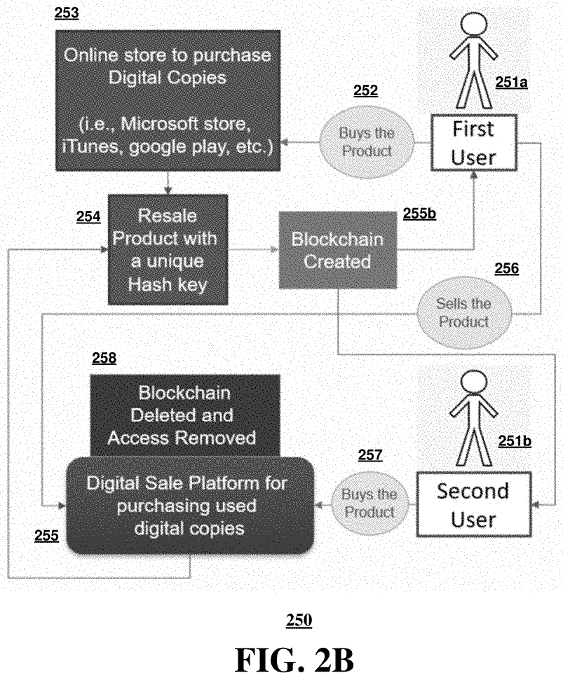

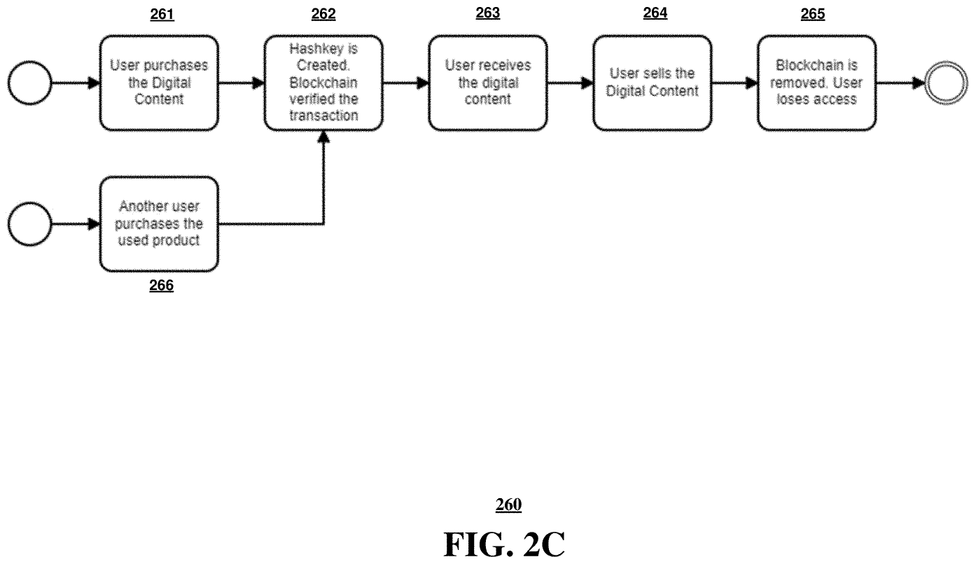

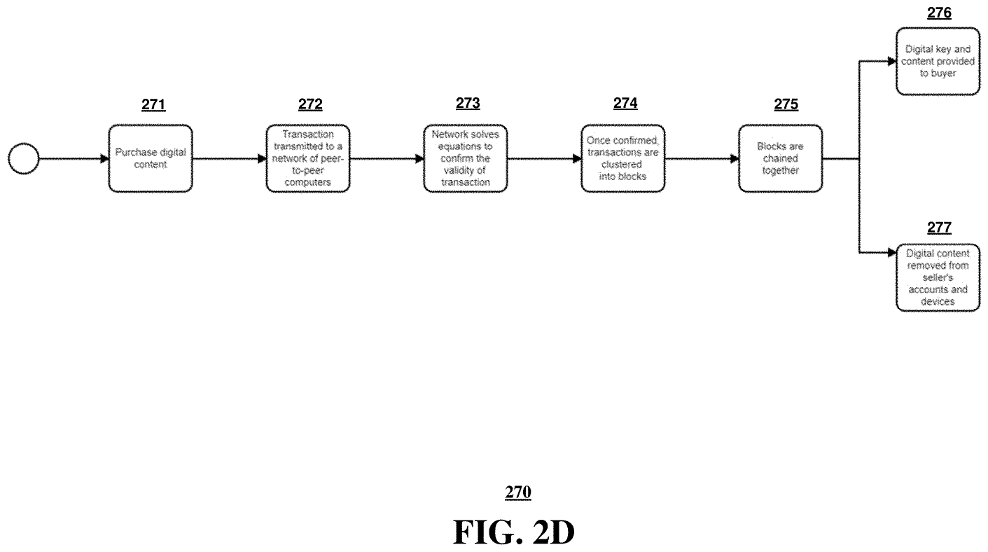

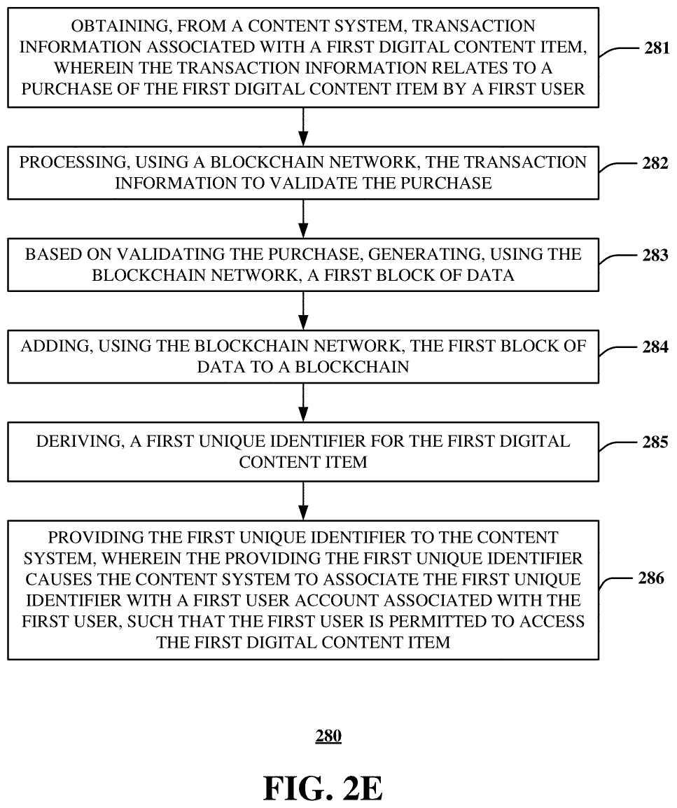

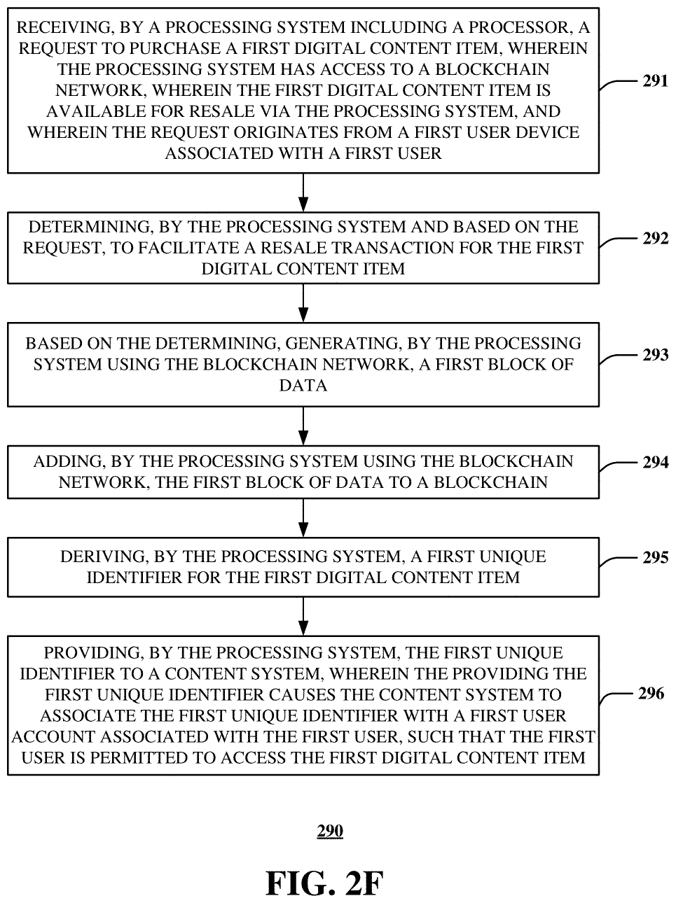

FIG. 2A is a block diagram illustrating an example, non-limiting embodiment of a system 200 functioning within, or operatively overlaid upon, the communications network 100 of FIG. 1 in accordance with various aspects described herein.

As shown in FIG. 2A, the system 200 may include a transaction management platform 205 communicatively coupled to a content system 210, which may include one or more server devices. The system 200 may also include user devices associated with corresponding users—e.g., a user device 215b associated with a user 215a and a user device 225b associated with a user 225a. Each of the user devices 215b and 225b can include, for example, a communication and/or computing device, such as a mobile phone (e.g., a smart phone, a radiotelephone, etc.), a desktop computer, a laptop computer, a tablet computer, a handheld computer, a gaming device, a wearable communication device (e.g., a smart wristwatch, a pair of smart eyeglasses, etc.), or a similar type of device. The transaction management platform 205, the content system 210, and the user devices 215b and 225b may communicate with one another in any suitable manner, such as over one or more wired and/or wireless networks.

In various embodiments, the content system 210 may include a merchant marketplace (e.g., a virtual store or the like) through which multiple digital content publishers can sell and distribute digital content (or digital content items) to users, such as the users 215a and 225a. A digital content item may include, for example, an application (e.g., a video game, etc.), a document (e.g., a book or other text-based material), multimedia (e.g., a piece of music, an audio clip, a movie, a video clip, etc.), and/or the like. In certain embodiments, the content system 210 may be operated by, or correspond to, a digital content publisher that designs, creates, or otherwise produces, digital content. In some embodiments, the content system 210 may provide one or more user interfaces via which users, such as the users 215a and 225a, can access digital content. As shown in FIG. 2A, for example, the content system 210 may administer and/or manage accounts for the users (e.g., a user account 215c for the user 215a, a user account 225c for the user 225a, etc.), and enable the users to log on to respective accounts (e.g., using the users' authentication credentials and/or the like), purchase digital content items, access and/or consume digital content items, and/or the like. In various embodiments, and as described in more detail below, the content system 210 may be capable of managing a user's right or permission to access a given digital content item, by adjusting one or more access-related entries in, or associated with, the user's account.

In various embodiments, an operator of the content system 210 (e.g., a virtual store provider and/or a digital content access provider, such as that associated with a digital content publisher) may be partnered with, or otherwise affiliated with, a provider of the transaction management platform 205, such that the content system 210 and the transaction management platform 205 may exchange communications to facilitate processing of digital content-related transactions (e.g., including resale transactions) and/or management of digital content access control. In some embodiments, the content system 210 may be integrated with the transaction management platform 205 and operated by a single provider entity.

As shown in FIG. 2A, the transaction management platform 205 may include a computing device (or devices) 205a that is communicatively coupled to a blockchain network 205b. The blockchain network 205b may include a distributed system of nodes (e.g., a peer-to-peer computer network of recordkeepers) that is configured to verify or validate transactions through the use of complex cryptographic functions or algorithms (e.g., asymmetric cryptographic functions and/or the like), generate corresponding blocks of data representing the transactions, and add the blocks to one or more blockchains. A blockchain is a ledger that is stored in each of the nodes, and that tracks entity-to-entity transfers by way of the blocks which are linked to one another in a chronologically ordered chain. A transaction may be validated, and a corresponding block of data may be generated and added to the blockchain, if all of the nodes reach a consensus based on the function(s) or algorithm(s). Each block of data on a blockchain may be associated with a unique value (e.g., a hash value and/or the like) that can be used to reference or identify the block.

Although not shown in FIG. 2A, in various embodiments, the transaction management platform 205 may, similar to the content system 210, administer and/or manage accounts for users (e.g., the user 215a, the user 225a, etc.), and enable the users to log on to respective accounts (e.g., using the users' authentication credentials and/or the like), initiate resales of digital content items, and/or the like.

As briefly described above, in various embodiments, the transaction management platform 205 may be capable of facilitating transactions (e.g., resale transactions) associated with digital content items, and managing user access to the digital content items based on the transactions. As shown by reference number 230, the user device 215b may submit, to the content system 210, a request to purchase a digital content item C. In various embodiments, the content system 210 may provide, to user devices (e.g., the user device 215b, the user device 225b, and/or the like), a user interface configured to present digital content items that are available for purchase, and receive user selections of digital content item(s) to purchase. In various embodiments, the request may be to make an original purchase of the digital content item C—e.g., the initial or first purchase of the digital content item C directly from the content system 210 (e.g., from a virtual store and/or the like provided by the content system 210).

As shown by reference number 232, the transaction management platform 205 may receive, from the content system 210, transaction information relating to the purchase. In various embodiments, the content system 210 may process the request to purchase the digital content item C (the request at 230), and provide the transaction information to the transaction management platform 205 based on the request. In some embodiments, the content system 210 may encrypt the transaction information (e.g., using one or more private keys and/or the like) prior to transmitting the transaction information to the transaction management platform 205. In certain embodiments, the transaction management platform 205 may additionally, or alternatively, receive transaction information (e.g., relating to the purchase) from a user device, such as the user device 215b.

The transaction information can include, for example, information regarding the user 215a (e.g., user profile data, information regarding the user account 215c, such as a user account ID, or the like), information regarding the user device 215b (e.g., a device ID, etc.), information regarding the digital content item C (e.g., a title associated with the digital content item C, information regarding a digital content publisher associated with the digital content item C, a type of the digital content item C (e.g., game, book, movie, etc.)), payment information (e.g., a method of payment, payment authorization data, etc.), and/or the like.

In various embodiments, the content system 210 may (e.g., based on an instruction from the transaction management platform 205, such as an instruction provided in connection with an affiliation or partnership between the content system 210 and the transaction management platform 205) offer to the user 215a (e.g., during an original purchase of the digital content item C) an option for the ability or right to resell the digital content item C at a later point (e.g., a resale option). Reselling the digital content item C can include reselling the digital content item C to another user of the transaction management platform 205 and/or another user of the content system 210, reselling the digital content item C directly to the transaction management platform 205 and/or the content system 210, and/or the like. In some embodiments, the content system 210 may charge the user 215a an additional, upfront fee (e.g., on top of, or in excess of, a base price or cost of the digital content item C) for choosing such an option, which may provide a financial incentive to the content system 210 (and/or a digital content publisher) to permit resale(s) of the digital content item C. In certain embodiments, the content system 210 may provide, and the transaction management platform 205 may receive, transaction information relating to a purchase of a digital content item (e.g., at 232) if (e.g., only if) the resale option is selected as part of the purchase. In alternate embodiments, the content system 210 may provide (e.g., in the transaction information) an indication of whether the resale option is selected as part of a purchase of a digital content item.

As shown by reference number 234, the transaction management platform 205 may process the transaction information. In various embodiments, the computing device 205a may receive the transaction information, and provide the transaction information (e.g., some or all of the transaction information, a manipulated or formatted version of the transaction information (e.g., formatted in a manner suitable for a blockchain pool to operate on), and/or the like) to the blockchain network 205b for processing. In some embodiments, such as in a case where the content system 210 includes, in the transaction information, an indication of whether the digital content item transacted for was purchased with a resale option, the transaction management platform 205 (e.g., the computing device 205a) may determine whether the transaction information indicates that the digital content item was indeed purchased with a resale option. In certain implementations, the transaction management platform 205 may process the transaction information if (e.g., only if) the transaction management platform 205 determines that the transaction information indicates that the digital content item was purchased with a resale option. In a case where the transaction management platform 205 determines that the transaction information does not indicate that the digital content item was purchased with a resale option, the transaction management platform 205 may refuse to further process the transaction information, and may notify the content system 210 accordingly.

In various embodiments, processing the transaction information may include performing one or more actions to verify the validity of the transaction—e.g., based on one or more cryptographic functions. As shown by reference number 234a, the transaction management platform 205 may, based on validating the transaction, generate, or otherwise derive, a block X of data and add the block X to a blockchain as a record of the transaction. In various embodiments, and as shown by reference number 234b, the transaction management platform 205 may, based on validating the transaction, generate, or otherwise, derive, a unique identifier P. In some embodiments, the transaction management platform 205 may generate the unique identifier P based on the block X of data (e.g., as part of deriving the block X of data). In these embodiments, for example, the unique identifier P may include a hash value that is representative of, or otherwise identifies, the block X of data. In other embodiments, the transaction management platform 205 may generate the unique identifier P independently of deriving the block X of data. In such embodiments, the transaction management platform 205 may associate the unique identifier P with the block X of data.

In some embodiments, the transaction management platform 205 can associate the unique identifier P and identifying information regarding the digital content item C (e.g., a description of the digital content item C, a title of the digital content item C, and/or the like) with the user 215a's account on the transaction management platform 205. For example, the user 215a may have an account on the transaction management platform 205, and may instruct the user device 215b to provide, to the content system 210, information (e.g., an API-based access token and/or the like) for accessing that account, which the content system 210 may use to access the account and/or may specify to the transaction management platform 205 (e.g., along with the transaction information described above with respect to reference number 232). Continuing the example, the transaction management platform 205 can, based on such access information or the like, access the user 215a's account and associate the user 215a's account with the unique identifier P and with the identifying information regarding the digital content item C therewith—e.g., by adding the unique identifier P and the identifying information to one or more data structure entries associated with the user 215a's account on the transaction management platform 205.

As shown by reference number 236, the transaction management platform 205 may transmit the unique identifier P to the content system 210. The content system 210 may, based on receipt of the unique identifier P, confirm that the transaction has been properly validated and recorded. In various embodiments, the transaction management platform 205 may transmit additional information (e.g., one or more results of a cryptographic function used in the validation, etc.) to the content system 210 to indicate that the transaction has been properly validated and recorded.

As shown by reference number 238, the content system 210 may associate the unique identifier P with the user account 215c. For example, in some embodiments, the content system 210 may add the unique identifier P to a data structure entry associated with the user account 215c. Association of the unique identifier P with the user account 215c may enable the user 215a (or the user device 215b) to access, and consume, the digital content item C (e.g., when the user 215a is logged on to the user account 215c). As an example, in a case where the digital content item C is a video game, association of the unique identifier P with the user account 215c may enable the user 215a (or the user device 215b) to access, and play the video game, when the user 215a is logged on to the user account 215c.

In exemplary embodiments, and as briefly discussed above, the transaction management platform 205 may be capable of facilitating post-purchase transactions (e.g., resales) of digital content items. For example, in a case where the user 215a previously selected the option for the ability or right to resell the digital content item C (e.g., as described above with respect to reference number 232), and submits a request to resell the digital content item C, the transaction management platform 205 may be capable of facilitating the resale transaction, such that the user 215a is credited for the resale (e.g., in the form of monetary compensation and/or the like), and access to the digital content item C is removed the user 215a's account (e.g., the user account 215c).

As shown by reference number 239a, the user device 215b may submit a request to resell (e.g., a resell request for) the digital content item C. In some embodiments, the user device 215b may submit the resell request to the content system 210. For example, the content system 210 may provide a user interface to the user device 215b that includes a user selectable option to resell the digital content item C, and may receive the resell request based upon a user selection of that option. In various embodiments, the content system 210 may, based upon receipt of the resell request, provide (239b) resale information to the transaction management platform 205. The resale information may include, for example, the unique identifier P associated with the digital content item C, information regarding the user 215a (e.g., user profile data, information regarding the user account 215c, such as a user account ID, or the like), information regarding the user device 215b (e.g., a device ID, etc.), information regarding the digital content item C (e.g., a title associated with the digital content item C, information regarding a digital content publisher associated with the digital content item C, a type of the digital content item C (e.g., game, book, movie, etc.)), payment information (e.g., a method of payment, payment authorization data, etc.), and/or the like.

In some embodiments, the user device 215b may alternatively submit the resell request to the transaction management platform 205. In such embodiments, for example, the transaction management platform 205 may (e.g., similar to the content system 210) provide a user interface to the user device 215b that includes a user selectable option to resell the digital content item C, and may receive the resell request based upon a user selection of that option. In certain embodiments, the transaction management platform 205 may present, on the user interface, identifying information regarding the digital content item C (e.g., a title thereof, the unique identifier P associated therewith, and/or the like), which the transaction management platform 205 may have previously associated with the user 215a's account on the transaction management platform 205 (e.g., as described above with respect to reference numbers 234, 234a, and 234b).

In various embodiments, in a case where a digital content item was not, in an original purchase thereof, acquired with a resale option (e.g., the resale option as described above), a user (e.g., or current owner of the digital content item) may not be provided with a user selectable option to resell the digital content item. For example, in a case where the user 215a did not acquire, in an original purchase, the digital content item C along with the resale option, the content system 210 and/or the transaction management platform 205 may not include, in a user interface provided to the user device 215b, a user selectable option to resell the digital content item C. In some embodiments, the content system 210 and/or the transaction management platform 205 may permit a user to resell a digital content item even in a case where the digital content item was not, in an original purchase thereof, acquired with a resale option (e.g., such as in a case where the digital content item was originally purchased from a source, such as the content system 210 or the like, prior to the source becoming affiliated with, partnered with, or implementing resale functionality associated with the transaction management platform 205 (or a provider thereof) (e.g., “legacy” purchases or transactions)). In these embodiments, the content system 210 and/or the transaction management platform 205 may, for example, based on a determination that the digital content item was not, in an original purchase thereof, acquired with a resale option, nevertheless provide a user selectable option to resell the digital content item, but may charge an additional fee if the user chooses such an option (e.g., as compensation for the source (e.g., similar to or the same as the upfront fee described above) or the like).

As shown by reference number 239c, the transaction management platform 205 may, based on the resell request and/or the resale information (e.g., received at 239b), determine to, or proceed to, facilitate a resale transaction.

In various embodiments, the transaction management platform 205 may facilitate the resale transaction by purchasing the digital content item C directly from the user 215a. In these embodiments, the transaction management platform 205 may present to the user 215a (e.g., via the user device 215b) an offer to acquire the digital content item C from the user 215a at a price that is based on one or more of a variety of factors, such as, for example, user demand, popularity, release date, etc. relating to the digital content item C. In a case where the user 215a decides to accept the offer (e.g., via response using the user device 215b), the transaction management platform 205 may cause a corresponding credit to be issued to the user 215a (e.g., by causing (e.g., via one or more third-party payment authentication systems and/or the like) a credit, such as a refund, a partial refund, virtual cash, etc., to be provided to the user's account on the transaction management platform 205, to the user account 215c on the content system 210, and/or to another account (e.g., a credit card account, a debit card account, a bank account, etc.) specified by the user 215a), and may inventory the digital content item C. In various embodiments, the transaction management platform 205 may generate a resale listing for the digital content item C (e.g., as an advertisement of the digital content item C) that identifies to other users (e.g., the user 225a and/or the like) that the digital content item C is available for purchase at resale (e.g., at a discount relative to the full, original price) from the transaction management platform 205. The resale listing may, for example, be user searchable (e.g., by title, by description, by cost, and/or the like) and be accessible via one or more user interfaces provided by the transaction management platform 205 (e.g., a resale interface and/or the like) that enables a user (e.g., the user 225a or the like) to select (e.g., via the user device 225b) the digital content item C for purchase. Example processing of a request to purchase a digital content item at resale, such as the digital content item C, is described in more detail below with respect to reference numbers 240, 244, 244a, 244b, 246, and 248.

In various embodiments, the transaction management platform 205 may not purchase the digital content item C directly from the user 215a, but may generate a resale listing (e.g., an advertisement) for the digital content item C (e.g., similar to that described above) to attract another user (e.g., the user 225a or the like) to purchase the item from the user 215a. In some embodiments, the transaction management platform 205 may provide an option to the user 215a (e.g., via the user device 215b) to set a price for the digital content item C. In some embodiments, the transaction management platform 205 may provide a suggested price based on one or more of a variety of factors, such as, for example, user demand, popularity, release date, etc. relating to the digital content item C. In various embodiments, the transaction management platform 205 may charge the user 215a a service fee (e.g., based on a percentage of the resale price) for facilitating the resale. In some embodiments, the transaction management platform 205 may apply an expiration date and/or time to a listing. In such embodiments, the transaction management platform 205 may, for example, automatically remove the listing upon expiration, renew the listing upon expiration (e.g., based on the user 215a's input requesting that the listing be renewed), purchase the digital content item C directly from the user 215a (e.g., similar to that described above, and, for example, at a further discounted price due to a lack of interested buyers), and/or the like.

As also shown by reference number 239c, the transaction management platform 205 may, as part of facilitating the resale transaction (and, e.g., based upon transaction management platform 205's direct purchase of the digital content item C from the user 215a or based upon a purchase thereof by another user (e.g., reference number 240)), identify the block X of data (e.g., by searching for the unique identifier P that is associated with the block X of data), and deactivate the block X of data, such that a record of the user 215a's association with the digital content item C is removed, archived, invalidated, nullified, no longer used, no longer referred or referenced to, and/or the like in the transaction management platform 205. In some embodiments, the transaction management platform 205 may cause the block X to be deleted from the blockchain. As shown by reference number 239d, the transaction management platform 205 may provide, to the content system 210, an instruction to deactivate, or otherwise remove or delete, the unique identifier P. As shown by reference number 239e, the instruction may cause the content system 210 to remove an association between the unique identifier P and the user account 215c (e.g., by deleting the unique identifier P from a data structure entry associated with the user account 215c and/or the like).

In this way, the user 215a may be compensated for the resale, and the user 215a's access to the digital content C (e.g., via the user account 215c and/or the user device 215b) may be removed accordingly.

As shown by reference number 240, the transaction management platform 205 may receive a buy request from the user device 225b to purchase the digital content item C. In various embodiments, the transaction management platform 205 may receive the purchase request based on a listing for the digital content item C (e.g., such as the resale listing described above). The buy request may include, for example, the unique identifier P associated with the digital content item C, information regarding the user 225a (e.g., user profile data, information regarding the user account 225c, such as a user account ID, or the like), information regarding the user device 225b (e.g., a device ID, etc.), information regarding the digital content item C (e.g., a title associated with the digital content item C, information regarding a digital content publisher associated with the digital content item C, a type of the digital content item C (e.g., game, book, movie, etc.)), payment information (e.g., a method of payment, payment authorization data, etc.), and/or the like. In a case where the transaction management platform 205 had already directly purchased the digital content item C from the user 215a, the transaction management platform 205 may proceed to process the buy request and cause the content system 210 to grant the user 225a with access to the digital content item C. In a case where the transaction management platform 205 had not directly purchased the digital content item C from the user 215a, the transaction management platform 205 may, in addition to processing the buy request and causing the content system 210 to grant the user 225a with access to the digital content item C, also deactivate the block X of data associated with the unique identifier P (e.g., such that the block X is removed, archived, invalidated, nullified, no longer used, no longer referred or referenced to, and/or the like) (e.g., as described above with respect to reference number 239c) and provide, to the content system 210, an instruction to deactivate, or otherwise remove or delete, the unique identifier P (e.g., as described above with respect to reference numbers 239d and 239e).

In various embodiments, the transaction management platform 205 may process the buy request and cause the content system 210 to grant the user 225a with access to the digital content item C in a manner similar to that described above with respect to reference numbers 234, 234a, 234b, 236, and 238 in relation to the user 215a's original purchase of the digital content item C. As shown in FIG. 2A, for example, the transaction management platform 205 may verify (244) the validity of the purchase, generate (244a) a block Y of data and add the block Y of data to a blockchain (e.g., the blockchain described above with respect to reference number 234a), generate (244b), or otherwise derive, a unique identifier Q (e.g., a hash key or the like), and provide (246) the unique identifier Q to the content system 210. The content system 210 may, based upon receipt of the unique identifier Q, associate (248) the unique identifier Q with the user account 225c. For example, in some embodiments, the content system 210 may add the unique identifier Q to a data structure entry associated with the user account 225c. Association of the unique identifier Q with the user account 225c may enable the user 225a (or the user device 225b) to access, and consume, the digital content item C (e.g., when the user 225a is logged on to the user account 225c).

In some embodiments, the user device 225b may additionally, or alternatively, provide the buy request to the content system 210. In certain embodiments, the content system 210 may provide a user interface to the user device 225b that includes a user selectable option to purchase the digital content item C (e.g., based upon the resale listing generated by the transaction management platform 205), and may receive the buy request based upon a user selection of that option. The content system 210 may, based upon receipt of the buy request, provide corresponding buy request information (not shown) to the transaction management platform 205, which the transaction management platform 205 may receive and process to facilitate the transaction for the user 225a.

In some embodiments, the content system 210 may provide a user interface to user devices (e.g., the user device 225b and/or the like) that enables users to submit searches for digital content items available for resale. The content system 210 may, based upon receipt of a search request for a digital content item, provide search information (not shown) to the transaction management platform 205. The search information may include, for example, information regarding the user, information regarding the user device, information regarding the digital content item of interest (e.g., a title associated with the digital content item, information regarding a digital content publisher associated with the digital content item, a type of the digital content item (e.g., game, book, movie, etc.)), payment information (e.g., a method of payment, payment authorization data, etc.), and/or the like. The transaction management platform 205 may, based upon receipt of the search information, determine whether the digital content item is available for resale (e.g., by searching for listings associated with the digital content item and/or the like). In a case where the transaction management platform 205 determines that the digital content item is not available for resale, the transaction management platform 205 may, for example, provide a response to the content system 210 indicating so, and/or provide one or more recommendations of other similar digital content items that may be available for resale. In a case where the transaction management platform 205 determines that the digital content item is available for resale (e.g., the digital content item C), the transaction management platform 205 may provide a response to the content system 210 indicating so, and/or proceed to facilitate the transaction for the user.

It is to be understood and appreciated that, although FIG. 2A has been described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

As one example, in various embodiments, the transaction management platform 205 may be capable of facilitating multiple resales of the same digital content item. For instance, the transaction management platform 205 may, based on a request by the user 225a to resell the digital content item C, perform one or more actions similar to or the same as those described above with respect to reference numbers 239a, 239b, 239c, 239d, 239e, 240, 244, 244a, 244b, 246, and 248 to facilitate the resale transaction, such that a record of the resale transaction is made in the blockchain network 205b, the user 225a no longer has access to the digital content item C in the user account 225c, and/or a buyer is granted access to the digital content item C in the buyer's account.

As another example, in some embodiments, the transaction management platform 205 may, for each resale of a digital content item, utilize the same unique identifier associated with the digital content item, rather than a different unique identifier. In these embodiments, the transaction management platform 205 may, for example, associate the original, unique identifier relating to the digital content item (e.g., the unique identifier P associated with the digital content item C) with a block of data generated for a buyer in the resale transaction (e.g., the block Y of data for the user 225a), and provide an instruction to the content system 210 to associate the unique identifier (e.g., the unique identifier P) with the buyer's user account (e.g., the user account 225c) and to remove the association between the unique identifier and the seller's account (e.g., the user account 215c). The transaction management platform 205 may perform similar steps for one or more subsequent resales of the digital content item. In alternate embodiments, the transaction management platform 205 may determine whether to use the same, current unique identifier for a resale transaction or to generate a different unique identifier therefor, in accordance with one or more predefined rules or patterns (e.g., the transaction management platform 205 may use the same unique identifier for only a certain quantity of resales, such as the first three resales, the first ten resales, and/or the like; generate a different unique identifier for every other resale or for each odd numbered (or even numbered) resale, such as the first resale, the third resale, and/or the like; etc.).

As yet another example, although reference number 239d has been described above as involving an instruction to the content system 210 to remove the association between the unique identifier P and the user account 215c, in some embodiments, the transaction management platform 205 may, at 239d, alternatively transmit the unique identifier P without the instruction, and the content system 210 may, based upon receipt of the unique identifier P, presume that the resale transaction has been properly validated and recorded, and proceed to remove the association between the unique identifier P and the user account 215c accordingly.

As a further example, in various embodiments, the content system 210 (e.g., a virtual (e.g., online) store server and/or a content server capable of providing user access to digital content items) and/or the transaction management platform 205 may impose a limit to a quantity of times that a digital content item may be resold. For example, in some embodiments, the transaction management platform 205 may, based upon a user request to make an original purchase of a digital content item or based upon data relating to such an original purchase (e.g., as described above with respect to reference numbers 230 and/or 232), store the unique identifier associated with the transaction (e.g., the unique identifier P) in an entry in a data structure, and associate the entry with a resale limit value and a counter value. Continuing the example, the transaction management platform 205 may, based upon a request to resell the digital content item (e.g., such as that described above with respect to reference number 239a), increment the counter value (or decrement the counter value, depending on how counting is implemented relative to the resale limit value), and may repeat the counting process for each resale transaction for the digital content item until the resale limit value is satisfied (e.g., when a total quantity of unique identifiers stored in the data structure entry, and associated with the original unique identifier P, satisfies the resale limit value), at which point, the transaction management platform 205 may deny any further requests to facilitate resale transactions for the digital content item. In this way, the content system 210 (e.g., a virtual store and/or a content server capable of providing user access to the digital content item) and/or the transaction management platform 205 may prevent numerous, repeated resales of the digital content item, thereby reducing or eliminating any negative impact that such repeated resales may have on original sales of the digital content item (e.g., at original, full prices).

As another example, in some embodiments, the transaction management platform 205 may be capable of facilitating resale transactions relating to multiple digital content items—e.g., where the digital content items must be purchased by a buyer as a bundle. In such embodiments, the transaction management platform 205 may generate, and/or associate, a respective unique identifier for each digital content item in the bundle, or alternatively, a single unique identifier for the bundle. In certain embodiments, the transaction management platform 205 may enable a buyer to release one or more of the digital content items from the bundle (and thus purchase only select ones in the bundle) by paying a higher price or a premium (e.g., $30 for one digital content item in a bundle of four digital content items that is priced at $100).

As yet another example, in some embodiments, the transaction management platform 205 may enable a user to place a digital content item up for lease by other users. In such embodiments, the transaction management platform 205 may maintain the lessor's unique identifier, but may generate a temporary unique identifier for the lessee, and cause the content system 210 to associate access to the leased digital content item with the temporary unique identifier rather than the lessor's unique identifier. In certain embodiments, the transaction management platform 205 may, upon expiration of the lease (e.g., as determined based on terms of the lease defined by the transaction management platform 205, the lessor, and/or the lessee), deactivate the temporary unique identifier, and cause the content system 210 to reassociate access to the digital content item with the lessor's unique identifier.

As a further example, although the transaction management platform 205 is described above as utilizing a blockchain network 205b to facilitate transactions relating to digital content items, in some embodiments, the transaction management platform 205 may facilitate such transactions without using such a blockchain network.

It is to be understood and appreciated that the quantity and arrangement of platforms, systems, accounts, networks, and devices shown in FIG. 2A are provided as an example. In practice, there may be additional platforms, systems, accounts, networks, and/or devices, fewer platforms, systems, accounts, networks, and/or devices, different platforms, systems, accounts, networks, and/or devices, or differently arranged platforms, systems, accounts, networks, and/or devices than those shown in FIG. 2A. For example, the system 200 can include more or fewer platforms, systems, accounts, networks, and/or devices, etc. In practice, therefore, there can be hundreds, thousands, millions, billions, etc. of such platforms, systems, accounts, networks, and/or devices. In this way, example system 200 can coordinate, or operate in conjunction with, a set of platforms, systems, accounts, networks, and/or devices and/or operate on data sets that cannot be managed manually or objectively by a human actor. Furthermore, two or more platforms, systems, accounts, networks, or devices shown in FIG. 2A may be implemented within a single platform, system, account, network, or device, or a single platform, system, account, network, or device shown in FIG. 2A may be implemented as multiple platforms, systems, accounts, networks, or devices. Additionally, or alternatively, a set of platforms, systems, accounts, networks, or devices of the system 200 may perform one or more functions described as being performed by another set of platforms, systems, accounts, networks, or devices of the system 200.

FIG. 2B is a block diagram illustrating an example, non-limiting embodiment of a system 250 functioning in, or in conjunction with, the communications network 100 of FIG. 1 and/or the system 200 of FIG. 2A in accordance with various aspects described herein. In various embodiments, the system 250 may be similar to, correspond to, include, or be included in, the system 200 of FIG. 2A. In some embodiments, aspects of the operation of the system 250 may be alternative(s) to the operation of the system 200.

As shown in FIG. 2B, the system 250 can include a virtual store 253 and a digital sale platform 255. In various embodiments, the virtual store 253 may be similar to, or correspond to, the content system 210, and the digital sale platform 255 may be similar to, or correspond to, the transaction management platform 205. As shown in FIG. 2B, a first user 251a may purchase (252) a digital product (e.g., with an option (254) that enables resale of the digital product) from the virtual store 253, a unique hash key may be associated (254) with the digital product (e.g., enabling the first user 251a to access and use or consume the digital product), and a block of data relating to the purchase may be added (255b) to a blockchain. As also shown in FIG. 2B, the first user 251a may choose to sell (256) the digital product to the digital sale platform 255, a second user 251b may choose to buy (257) the digital product from the digital sale platform 255, a new unique hash key may be associated (254) with the digital product (e.g., enabling the second user 251b to access and use or consume the digital product), the block of data relating to the initial purchase by the user 251a may be deleted (or otherwise deactivated such that the block of data is removed, archived, invalidated, nullified, no longer used, no longer referred or referenced to, and/or the like) (258), the first user 251a's access to the digital product may be removed (258), and a new block of data relating to the resale transaction may added (255b) to the blockchain. In some embodiments, some or all of the steps shown in FIG. 2B may be similar to, or correspond to, some or all of the various actions (and/or alternatives thereto) described above with respect to FIG. 2A.

FIG. 2C depicts an illustrative embodiment of a method 260 in accordance with various aspects described herein. In some embodiments, one or more process blocks of FIG. 2C can be performed by a transaction management platform, such as the transaction management platform 205. In some embodiments, one or more process blocks of FIG. 2C may be performed by another device or a group of devices separate from or including the transaction management platform, such as the content system 210, the user device 215b, the user device 225b, and/or the like.

As shown in FIG. 2C, a first user may purchase (261) digital content, a hash key may be created (262), a blockchain network may verify (262) the transaction and add a corresponding block of data to a blockchain for the transaction, and the user may receive (263) the digital content (or access to the digital content). At 264, the user may sell, or resell, the digital content, and at 265, the block of data may be deleted (or otherwise deactivated such that the block of data is removed, archived, invalidated, nullified, no longer used, no longer referred or referenced to, and/or the like) and the user may lose access to the digital content. As shown in FIG. 2C, another user may purchase (266) the digital content (e.g., based on a resale of the digital content by the first user), and the same or a similar process (e.g., steps 262-265 and/or the like) may be effected. In some embodiments, some or all of the steps shown in FIG. 2C may be similar to, or correspond to, some or all of the various actions (and/or alternatives thereto) described above with respect to FIG. 2A and/or some or all of the various actions (and/or alternatives thereto) described above with respect to FIG. 2B.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D depicts an illustrative embodiment of a method 270 in accordance with various aspects described herein. In some embodiments, one or more process blocks of FIG. 2D can be performed by a transaction management platform, such as the transaction management platform 205. In some embodiments, one or more process blocks of FIG. 2D may be performed by another device or a group of devices separate from or including the transaction management platform, such as the content system 210, the user device 215b, the user device 225b, and/or the like.

In various embodiments, the method 270 may correspond to a resale transaction similar to that described above with respect to reference numbers 240, 244, 244a, 244b, 246, and 248 of FIG. 2A and/or resale-related actions described above with respect to FIGS. 2B and/or 2C. As shown in FIG. 2D, a buyer may purchase (271) digital content that is for resale (e.g., resale by a seller or digital sales platform), the transaction may be transmitted (272) to a network of peer-to-peer computers (e.g., a blockchain network of nodes and/or the like), the network may confirm validity (273) of the transactions (e.g., by solving one or more equations, such as cryptographic-related equations or functions), the network may add or cluster (274, 275) one or more blocks of data into a blockchain, a digital key and the digital content may be provided (276) to the buyer, and the digital content may be removed (277) from the seller's accounts and/or devices.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2E depicts an illustrative embodiment of a method 280 in accordance with various aspects described herein. In some embodiments, one or more process blocks of FIG. 2E can be performed by a transaction management platform or a digital sale platform, such as the transaction management platform 205 or the digital sale platform 255. In some embodiments, one or more process blocks of FIG. 2E may be performed by another device or a group of devices separate from or including the transaction management platform or the digital sale platform, such as the content system 210, the user device 215b, the user device 225b, the online store 253, and/or the like.

At 281, the method can include obtaining, from a content system, transaction information associated with a first digital content item, where the transaction information relates to a purchase of the first digital content item by a first user. For example, the transaction management platform 205 and/or the digital sale platform 255 can obtain, from a content system, transaction information associated with a first digital content item in a manner similar to that described above with respect to the system 200 of FIG. 2A and/or the system 250 of FIG. 2B, where the transaction information relates to a purchase of the first digital content item by a first user.

At 282, the method can include processing, using a blockchain network, the transaction information to validate the purchase. For example, the transaction management platform 205 and/or the digital sale platform 255 can process, using a blockchain network, the transaction information to validate the purchase in a manner similar to that described above with respect to the system 200 of FIG. 2A and/or the system 250 of FIG. 2B.

At 283, the method can include, based on validating the purchase, generating, using the blockchain network, a first block of data. For example, the transaction management platform 205 and/or the digital sale platform 255 can, based on validating the purchase, generate, using the blockchain network, a first block of data in a manner similar to that described above with respect to the system 200 of FIG. 2A and/or the system 250 of FIG. 2B.

At 284, the method can include adding, using the blockchain network, the first block of data to a blockchain. For example, the transaction management platform 205 and/or the digital sale platform 255 can add, using the blockchain network, the first block of data to a blockchain in a manner similar to that described above with respect to the system 200 of FIG. 2A and/or the system 250 of FIG. 2B.

At 285, the method can include deriving a first unique identifier for the first digital content item. For example, the transaction management platform 205 and/or the digital sale platform 255 can derive a first unique identifier for the first digital content item in a manner similar to that described above with respect to the system 200 of FIG. 2A and/or the system 250 of FIG. 2B.

At 286, the method can include providing the first unique identifier to the content system, where the providing the first unique identifier causes the content system to associate the first unique identifier with a first user account associated with the first user, such that the first user is permitted to access the first digital content item. For example, the transaction management platform 205 and/or the digital sale platform 255 can provide the first unique identifier to the content system in a manner similar to that described above with respect to the system 200 of FIG. 2A and/or the system 250 of FIG. 2B, where the providing the first unique identifier causes the content system to associate the first unique identifier with a first user account associated with the first user, such that the first user is permitted to access the first digital content item.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2F depicts an illustrative embodiment of a method 290 in accordance with various aspects described herein. In some embodiments, one or more process blocks of FIG. 2F can be performed by a transaction management platform or a digital sale platform, such as the transaction management platform 205 or the digital sale platform 255. In some embodiments, one or more process blocks of FIG. 2F may be performed by another device or a group of devices separate from or including the transaction management platform or the digital sale platform, such as the content system 210, the user device 215b, the user device 225b, the online store 253, and/or the like.

At 291, the method can include receiving, by a processing system including a processor, a request to purchase a first digital content item, where the processing system has access to a blockchain network, where the first digital content item is available for resale via the processing system, and where the request originates from a first user device associated with a first user. For example, the transaction management platform 205 and/or the digital sale platform 255 can receive a request to purchase a first digital content item in a manner similar to that described above with respect to the system 200 of FIG. 2A and/or the system 250 of FIG. 2B, where the processing system has access to a blockchain network, where the first digital content item is available for resale via the processing system, and where the request originates from a first user device associated with a first user.

At 292, the method can include determining, by the processing system and based on the request, to facilitate a resale transaction for the first digital content item. For example, the transaction management platform 205 and/or the digital sale platform 255 can determine, based on the request, to facilitate a resale transaction for the first digital content item in a manner similar to that described above with respect to the system 200 of FIG. 2A and/or the system 250 of FIG. 2B.

At 293, the method can include, based on the determining, generating, by the processing system using the blockchain network, a first block of data. For example, the transaction management platform 205 and/or the digital sale platform 255 can, based on the determining, generate a first block of data in a manner similar to that described above with respect to the system 200 of FIG. 2A and/or the system 250 of FIG. 2B.

At 294, the method can include adding, by the processing system using the blockchain network, the first block of data to a blockchain. For example, the transaction management platform 205 and/or the digital sale platform 255 can add the first block of data to a blockchain in a manner similar to that described above with respect to the system 200 of FIG. 2A and/or the system 250 of FIG. 2B.

At 295, the method can include deriving, by the processing system, a first unique identifier for the first digital content item. For example, the transaction management platform 205 and/or the digital sale platform 255 can derive a first unique identifier for the first digital content item in a manner similar to that described above with respect to the system 200 of FIG. 2A and/or the system 250 of FIG. 2B.

At 296, the method can include providing, by the processing system, the first unique identifier to a content system, where the providing the first unique identifier causes the content system to associate the first unique identifier with a first user account associated with the first user, such that the first user is permitted to access the first digital content item. For example, the transaction management platform 205 and/or the digital sale platform 255 can provide the first unique identifier to a content system in a manner similar to that described above with respect to the system 200 of FIG. 2A and/or the system 250 of FIG. 2B, where the providing the first unique identifier causes the content system to associate the first unique identifier with a first user account associated with the first user, such that the first user is permitted to access the first digital content item.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

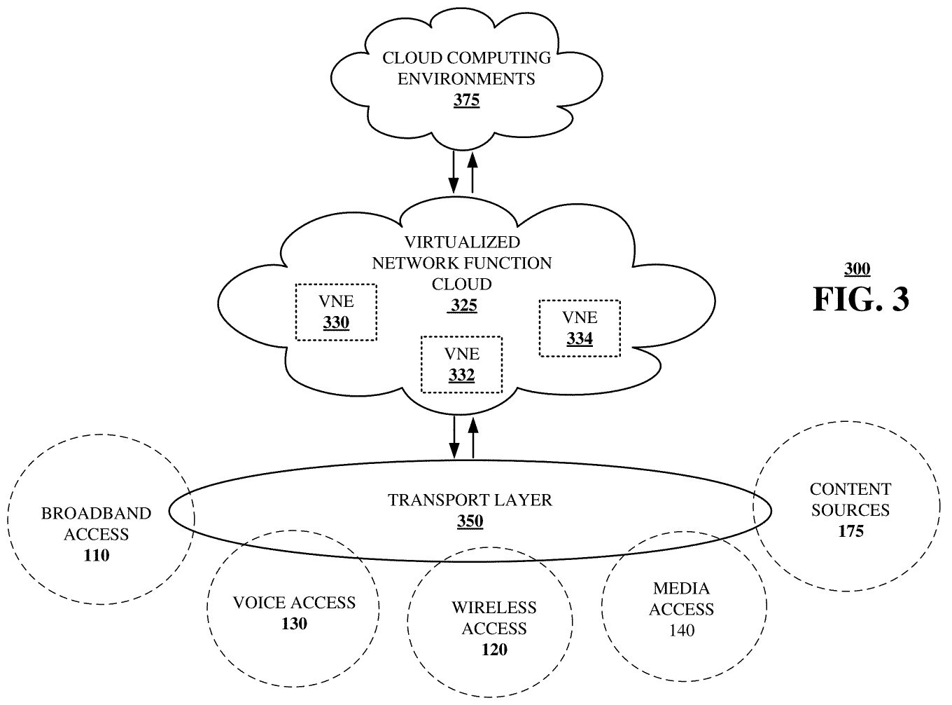

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, the subsystems and functions of system 250, and/or methods 260, 270, 280, and 290 presented in FIGS. 1 and 2A-2F. For example, virtualized communications network 300 can facilitate, in whole or in part, processing of transactions (e.g., resale transactions) associated with digital content items (e.g., video games, applications, books, movies, music, and/or the like), and managing user access to the digital content items based on the transactions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

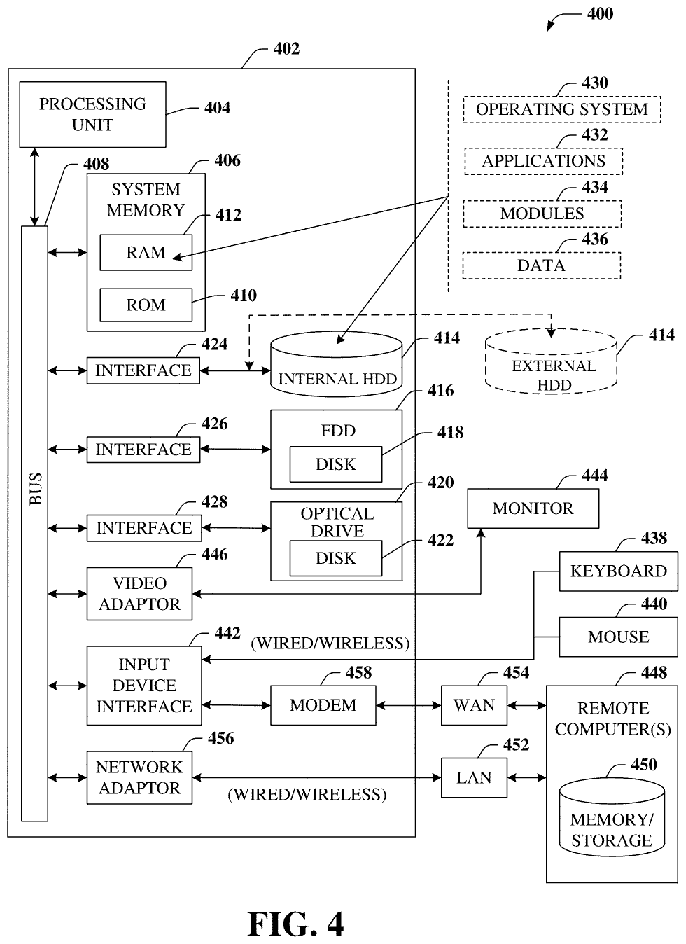

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, processing of transactions (e.g., resale transactions) associated with digital content items (e.g., video games, applications, books, movies, music, and/or the like), and managing user access to the digital content items based on the transactions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

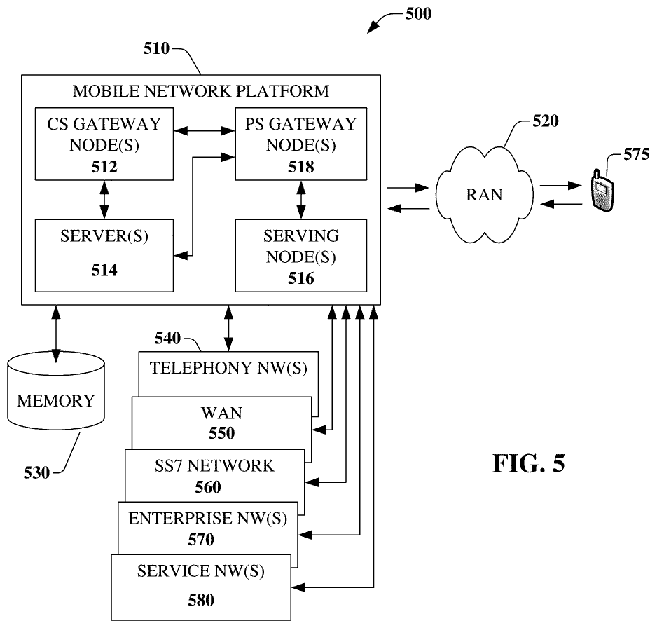

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, processing of transactions (e.g., resale transactions) associated with digital content items (e.g., video games, applications, books, movies, music, and/or the like), and managing user access to the digital content items based on the transactions. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

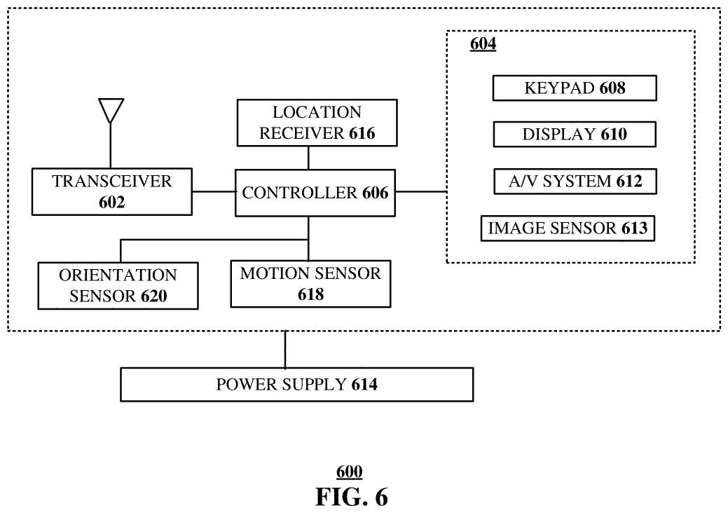

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, processing of transactions (e.g., resale transactions) associated with digital content items (e.g., video games, applications, books, movies, music, and/or the like), and managing user access to the digital content items based on the transactions.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor, wherein the processing system has access to a blockchain network; and
a memory that stores executable instructions that, when executed by the processing system, facilitate performance of operations, the operations comprising:
obtaining, from a content system, transaction information associated with a first digital content item, wherein the transaction information relates to a purchase of the first digital content item by a first user;
processing, using the blockchain network, the transaction information to validate the purchase;
based on validating the purchase, generating, using the blockchain network, a first block of data;
adding, using the blockchain network, the first block of data to a blockchain;
deriving a first unique identifier for the first digital content item; and
providing the first unique identifier to the content system, wherein the providing the first unique identifier causes the content system to associate the first unique identifier with a first user account associated with the first user, such that the first user is permitted to access the first digital content item.

2. The device of claim 1, wherein the operations further comprise:
receiving, from a first user device associated with the first user, a first request to resell the first digital content item;
performing an action to cause a credit to be provided to the first user;
causing, using the blockchain network, the first block of data to be deactivated based on the first request; and
transmitting, to the content system, an instruction to remove an association between the first unique identifier and the first user account, such that the first user is no longer permitted to access the first digital content item.

3. The device of claim 2, wherein the first request to resell the first digital content item is based on a resale option that was selected by the first user during the purchase of the first digital content item, and wherein selection of the resale option during the purchase of the first digital content item enables the first user device to submit the first request to resell the first digital content item.

4. The device of claim 2, wherein the operations further comprise:
receiving a second request to purchase the first digital content item, wherein the second request originates from a second user device associated with a second user;
determining, based on the second request, to facilitate a resale transaction for the first digital content item;
based on the determining, generating, using the blockchain network, a second block of data;
adding, using the blockchain network, the second block of data to a blockchain;
deriving a second unique identifier for the first digital content item; and
providing the second unique identifier to the content system, wherein the providing the second unique identifier causes the content system to associate the second unique identifier with a second user account associated with the second user, such that the second user is permitted to access the first digital content item.

5. The device of claim 1, wherein the first digital content item comprises one of a video game, a movie, music, an application, a book, or a combination thereof.

6. The device of claim 1, wherein content system is operated by a virtual marketplace provider.

7. The device of claim 1, wherein the content system is operated by a digital content publisher.

8. The device of claim 1, wherein the first digital content item was not previously purchased by another user.

9. The device of claim 1, wherein the operations further comprise associating the first unique identifier with the first block of data.

10. The device of claim 1, wherein the first unique identifier comprises a hash key.

11. A non-transitory machine-readable medium, comprising executable instructions that, when executed by a processing system including a processor, facilitate performance of operations, the operations comprising:
providing, to a transaction management platform, transaction information associated with a first digital content item, wherein the transaction information relates to a purchase of the first digital content item by a first user, and wherein the providing the transaction information enables the transaction management platform to process, using a blockchain network, the transaction information to validate the purchase, and to generate, based on validating the transaction information, a first unique identifier for the first digital content item;
receiving, from the transaction management platform, the first unique identifier responsive to the providing the transaction information to the transaction management platform; and
based on the receiving the first unique identifier, causing the first unique identifier to become associated with a first user account corresponding to the first user to enable the first user to access and consume the first digital content item.

12. The non-transitory machine-readable medium of claim 11, wherein the processing system is included in a content system, and wherein the first user account is maintained by the content system.

13. The non-transitory machine-readable medium of claim 11, wherein the first digital content item comprises one of a video game, a movie, music, an application, a book, or a combination thereof.

14. The non-transitory machine-readable medium of claim 11, wherein the first unique identifier comprises a hash key.

15. The non-transitory machine-readable medium of claim 11, wherein the operations further comprise receiving, from a first user device associated with the first user, a request to purchase the first digital content item.

16. A method, comprising:
receiving, by a processing system including a processor, a request to purchase a first digital content item, wherein the processing system has access to a blockchain network, wherein the first digital content item is available for resale via the processing system, and wherein the request originates from a first user device associated with a first user;
determining, by the processing system and based on the request, to facilitate a resale transaction for the first digital content item;
based on the determining, generating, by the processing system using the blockchain network, a first block of data;
adding, by the processing system using the blockchain network, the first block of data to a blockchain;
deriving, by the processing system, a first unique identifier for the first digital content item; and
providing, by the processing system, the first unique identifier to a content system, wherein the providing the first unique identifier causes the content system to associate the first unique identifier with a first user account associated with the first user, such that the first user is permitted to access the first digital content item.

17. The method of claim 16, wherein the receiving the request to purchase the first digital content item comprises receiving the request from the content system.

18. The method of claim 16, wherein the first digital content item is previously associated with another unique identifier that is different from the first unique identifier.

19. The method of claim 16, wherein the first digital content item is not a physical object.

20. The method of claim 16, wherein the first unique identifier comprises a hash key.
